(19) United States
(12) Patent Application Publication
(10) Pub. No.: US 2013/0031714 A1
(43) Pub. Date: Feb. 7, 2013

(54) RETENTION CLIP

(71) Applicants: H. Charles Li, Peachtree City, GA (US); William J. Drury, Peachtree City, GA (US)

(72) Inventors: H. Charles Li, Peachtree City, GA (US); William J. Drury, Peachtree City, GA (US)

(73) Assignee: Custom Molded Products, Inc., Tyrone, GA (US)

(21) Appl. No.: 13/196,942

(22) Filed: Aug. 3, 2011

(51) Int. Cl. A47K 3/02; F16B 2/20; B23P 17/04; F16M 13/02

(52) U.S. Cl. 4/584; 248/224.8; 29/428

(57) ABSTRACT

A retention clip for mounting spa fixtures through the wall of a spa reservoir. A retention clip may be placed in a hole that has been bored through a spa wall. Bore positioning features of the clip may provide a means for advantageously centering the retention clip in the hole. A flange mates to the surface of the tub wall once the retention clip is inserted through the bore and a plurality of retention fingers will extend beyond the opposite side of the tub wall. Subsequently, a fixture may be inserted through the retention clip. A chamfered feature of the fixture physically communicates with the retention fingers and operates to apply a force radially outward to each, thereby causing retention tongues located on the spines of each retention finger to engage a groove feature on the fixture body.

### BACKGROUND OF THE INVENTION

1. Technical Field

The present invention generally is in the technical field of retention clips for attaching accessories to supports, and more specifically is in the technical field of retention clips for attaching spa and pool accessories to spa and pool walls, shells, and decks.

2. Prior Art

Most spas, jetted tubs, pools and the like essentially begin as pre-molded, fiberglass reservoirs which must be retrofitted with all the accessories needed to create a spa experience. Most of the accessories of a spa, such as the circulation tubing, pumps, and electrical systems are mounted on or around the exterior of the reservoir wall. Notably, the exterior of the reservoir wall is not normally seen by a user of a spa, as the entire reservoir, accessories and all, is ultimately mounted into an aesthetically pleasing support structure or deck.

The various fixtures and fittings, such as jets and air adjustment valves, are mounted in holes bored through the wall of the fiberglass reservoir. As such, one side of the fixture is necessarily seen by the user of a spa (e.g., the nozzle for a water jet or the actuator knob for an air adjustment valve) while the other side extends through the reservoir wall and into the hidden space defined by the exterior of the reservoir and the interior of the aesthetic support structure. Because the various fixtures are mounted in holes bored through the wall of the reservoir, it is necessary that the fixtures be mounted in a structurally secure manner.

Spa fixture mounting systems presently used in the art usually comprise a threaded aspect on the body of the fixture that is configured to receive a nut. The nut is tightened onto the fixture threads and against the exterior wall of the reservoir, thus securing the fixture in the mounting hole. Notably, threading a nut onto a fixture body may require the portion of the fixture body that is exposed to the interior of the reservoir be supported while the nut is mounted and tightened from the exterior side of the reservoir wall. One of ordinary skill in the art will recognize that supporting a fixture on one side of the reservoir wall while a nut is mounted and tightened from the other side of the reservoir wall can be a difficult and cumbersome task.

Besides being difficult to mount, threaded spa fixtures may allow water to leak through the mounting hole when the threaded connection loosens. Due to normal use of the spa, the nut may gradually loosen over time, thus breaking the seal between the fixture body and the interior wall of the tub.

Accordingly, there is a need for a fixture mounting device and system that can be installed from a single side of a spa reservoir. Moreover, what is needed in the art is a retention clip that can be used to securely, and rigidly, maintain the position of a spa fitting in a mounting hole without loosening from normal spa usage. It is to this need and others that the present invention is directed.

### BRIEF SUMMARY OF THE INVENTION

Briefly, the presently disclosed embodiments, as well as features and aspects thereof, are directed towards a retention clip for mounting spa fixtures through the wall of a spa reservoir. Advantageously, a retention clip, or its equivalent, may be leveraged in lieu of a nut and threads for positioning and mounting a fixture through a spa wall or other surface.

The retention clip may include a flange element that defines both an outer diameter and an inner diameter such that the overall retention clip generally takes the form of a ring. Positioned substantially along the inner diameter of the clip may be one or more bore positioning features extending substantially perpendicular to the ring-like planar base surface defined by the flange. Further, a series of retention fingers may be arrayed concentrically with the overall ring shape that is collectively defined by the aforementioned flange and bore positioning features. The retention fingers may extend substantially perpendicular from the base surface defined by the flange and along a circumferential path having a diameter less than the circumferential path along which the bore positioning features are placed. That is, one of ordinary skill in the art may recognize that the retention fingers are positioned inside of the bore positioning features.

A retention clip may be placed in a hole that has been bored through a spa wall such that the flange prevents the retention clip from passing completely through the hole. Thus, the flange mates with the wall of the spa and provides a sealing mechanism. Further, the bore positioning features may provide a means for advantageously centering the retention clip in the bore. Notably, once the retention clip is inserted through the bore such that the flange mates to the surface of the tub wall, the bore positioning feature will be substantially positioned generally centrally within the hole and the plurality of retention fingers will extend beyond the opposite side of the tub wall. Subsequently, a fixture, such as a water jet or air intake valve, may be inserted through the inner diameter of the ring-like retention clip. As the fixture is inserted through the retention clip, a chamfered or sloped feature of the fixture body will physically communicate with the retention fingers and operate to apply a force radially outward to each, thereby causing both the retention fingers to engage the surface of the spa wall so as to hold the retention clip onto the spa wall, and the retention tongues located on the spines of each retention finger to engage a groove feature on the fixture body so as to hold the fixture body within the retention clip. At such point, the fixture is installed and securely held in place.

A complete understanding of the present invention may be obtained by reference to the accompanying drawings, when considered in conjunction with the subsequent, detailed description of preferred embodiments in which like elements and components bear the same designations and numbering throughout the figures.

### BRIEF DESCRIPTION OF THE DRAWINGS

In the figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral encompass all parts having the same reference numeral in all figures.

FIG. 1 is an exploded side view of a prior art fixture assembly comprising a threaded fixture body and nut component.

FIG. 2A is an elevation view of a retention clip for spa fixtures, according to an exemplary embodiment of the invention.

FIG. 2B is a top view of the exemplary retention clip for spa fixtures depicted in FIG. 2A.

FIG. 3A is an exploded side view of a fixture assembly according to an exemplary embodiment of the invention and comprising the retention clip for spa fixtures depicted in FIGS. 2A-2B.

FIG. 3B is a side view of the exemplary fixture assembly of FIG. 3A, shown in an assembled state.

FIG. 4A is a cross-sectional side view of the exemplary assembled fixture assembly of FIG. 3B, depicted prior to insertion of the fixture.

FIG. 4B is a cross-sectional side view of the exemplary assembled fixture assembly of FIG. 3B.

### DETAILED DESCRIPTION OF PREFERRED EMBODIMENTS

Aspects, features and advantages of several exemplary embodiments of the present invention will become better understood with regard to the following description in connection with the accompanying drawings. It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto.

The word exemplary is used herein to mean serving as an example, instance, or illustration. Any embodiment or aspect described herein as exemplary is not necessarily to be construed as exclusive, preferred or advantageous over other embodiments or aspects.

The terms fixture, fitting, spa fixture, spa fitting, valve and the like are used interchangeably and generally directed toward any component that may be mounted in a hole bored through a wall or other surface including, but not limited to, an air intake valve, a water jet, an air jet, a venturi water jet, a floor drain, a suction intake, a faucet, a drain mechanism, general plumbing hardware, etc. As such, the description of various embodiments in the context of retrofitting a spa will not be construed to limit the scope of the disclosure to spa fitting applications only.

The terms spa, tub, spa wall, tub wall, reservoir, reservoir wall and the like are used interchangeably and generally directed toward any wall or surface through which a fixture may be mounted. As such, the description of embodiments in the context of retrofitting a spa will not be construed to limit the scope of the disclosure to spa fitting applications only. Rather, it is envisioned that embodiments of the invention may be leveraged to quickly and securely mount any device or component configured to be received by a hole bored through a surface.

The presently disclosed embodiments, as well as features and aspects thereof, are directed towards providing a method and device for quickly and securely mounting spa fixtures through a tub wall. Methods and devices presently known in the art are cumbersome to use and prone to failure.

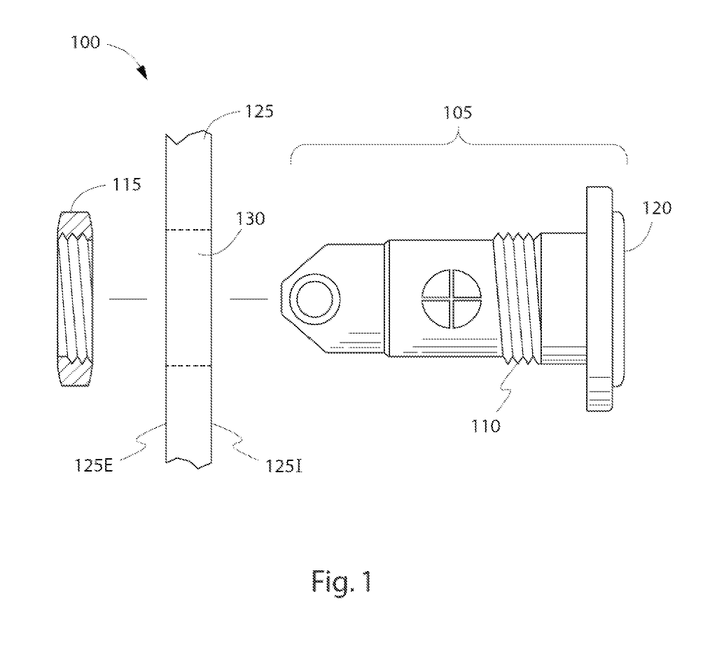

FIG. 1 is an exploded side view of a fixture assembly 100 comprising a threaded fixture 105 and nut component 115. The fixture assembly 100 is typical of assemblies presently used in the art of spa retrofitting. As is apparent from the exploded view, the fixture 105 is configured to be inserted through a bore 130 in spa wall 125. Once inserted, the actuator 120 (e.g., the adjustment mechanism for an air intake valve) will remain accessible on the interior surface 1251 of the tub wall 125 while the valve and thread 110 portions of the fixture 105 will extend through tub wall 125 and beyond an exterior surface 125E. Subsequently, the nut 115 may be screwed onto the threads 110 and until tight against the interior tub wall surface 125E.

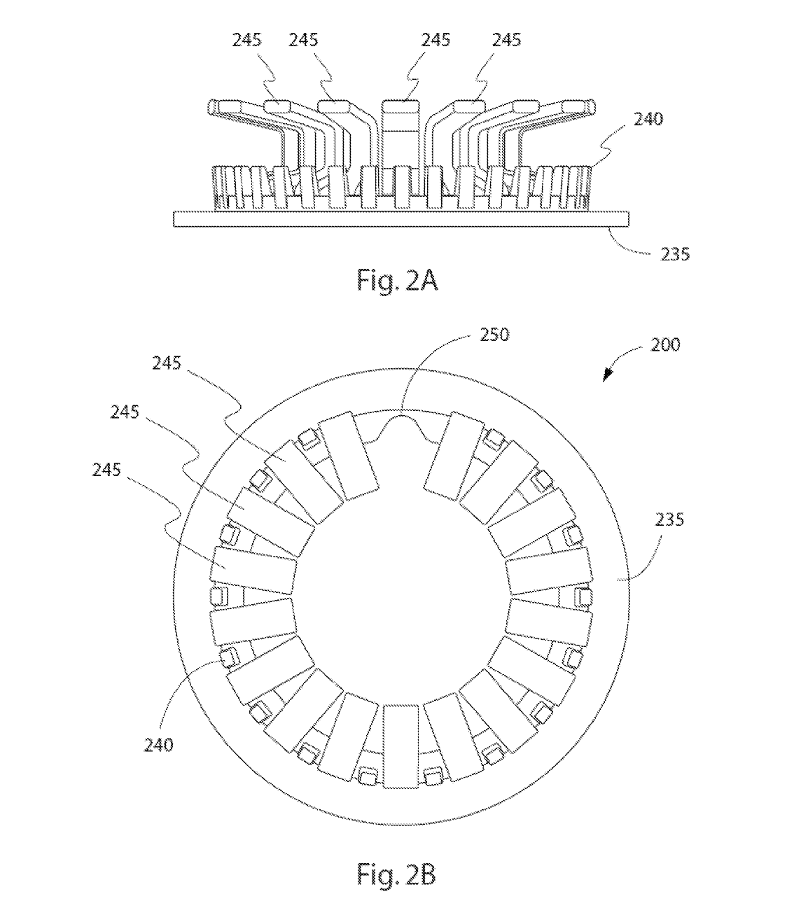

FIGS. 2A and 2B are elevation and top views, respectively, of an exemplary retention clip 200 for spa fixtures according to an exemplary embodiment of the invention. Advantageously, a retention clip 200, or its equivalent, may be leveraged in lieu of a nut and threads for positioning a fixture through a spa wall or other surface.

A flange element 235 defines an outer diameter and an inner diameter such that the retention clip 200 generally takes the form of a ring. Positioned substantially along the inner diameter of the clip 200 may be one or more bore positioning features 240 extending substantially perpendicular to a planar base surface defined by the flange 235. Further, a series of retention fingers 245 may be arrayed concentrically with the overall ring shape defined by the flange 235 and bore positioning features 240. The retention fingers 245 may extend substantially perpendicular from the base surface defined by the flange 235 and along a circumferential path having a diameter less than the circumferential path along which the bore positioning features 240 are placed. That is, one of ordinary skill in the art may recognize that the retention fingers 245 are positioned inside of the bore positioning features 240.

In some embodiments, the retention clip 200 may include a fixture insertion relief aspect 250. As can be seen in the FIG. 2B drawing, the exemplary retention clip 200 includes a break in the array of retention fingers 245. One of ordinary skill in the art will recognize the novelty of including a fixture insertion relief aspect 250 in order to accommodate the eventual insertion of a fixture through the inner diameter of the retention clip 200.

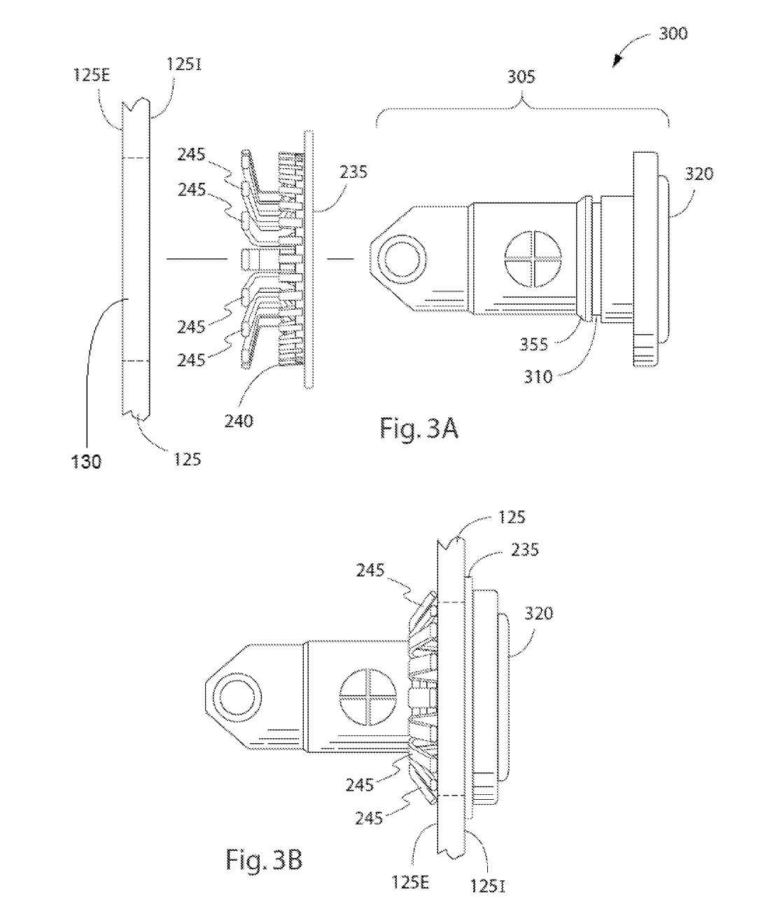

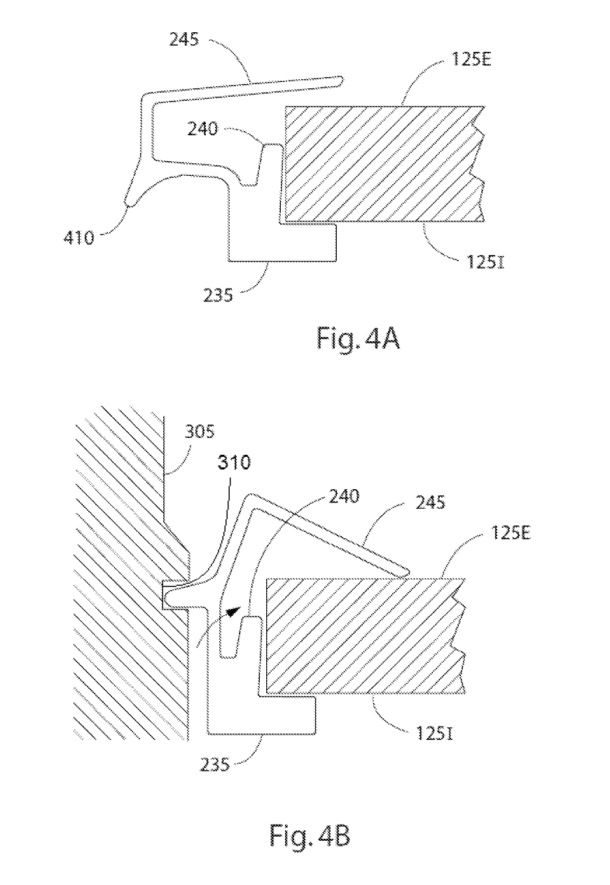

FIG. 3A is an exploded side view of a fixture assembly 300 according to an exemplary embodiment of the invention and comprising the exemplary retention clip 200 described relative to FIGS. 2A-2B. FIG. 3B is a side view of the exemplary fixture assembly 300 depicted in an assembled state. As can be inferred from the FIG. 3 illustrations, the exemplary retention clip 200 is configured to be received by a bore 130 in a spa wall 125 such that the flange 235 prevents the retention clip 200 from passing completely through the bore (see FIGS. 4A-4B). Moreover, one of ordinary skill in the art will recognize that a bore positioning feature 240 may provide a means for advantageously centering the retention clip 200 in the bore. Further, and as described above, a plurality of retention fingers 245 may be arrayed along the circumference of the inner diameter of the flange 235, extending substantially perpendicularly from the surface of the flange 235 and originating on a circumferential path that is inside of the bore positioning feature 240.

Notably, once the retention clip 200 is inserted through bore 130 such that flange 235 is juxtaposed to interior surface 1251, the bore positioning feature 240 will be substantially positioned within the bore 130 and the plurality of retention fingers 245 will extend beyond exterior surface 125E. Subsequently, fixture 305 may be inserted through the inner diameter of retention clip 200. As fixture 305 is inserted through retention clip 200, a chamfer 355 or other feature of fixture 305 may operate to apply a force radially outward to each of the retention fingers 245, thereby causing retention tongues 410 (see FIG. 4) located on the spines of each retention finger 245 to engage a groove feature 310, or its equivalent, of the fixture 305.

The diameter of the groove feature 310 may exceed an inner diameter defined by the array of retention fingers 245 when the retention clip 200 is not in use. As such, one of ordinary skill in the art will recognize that, once the fixture 305 is inserted through retention clip 200 such that retention tongues 410 engage groove feature 310, each of the array of retention fingers 245 may be forced outward from a normally relaxed position. Advantageously, when forced outward from a relaxed position and held, retention fingers 245 may anchor against exterior surface 125E and apply a constant force back on fixture 305 via retention tongues 410 into groove feature 310, thereby securing fixture 305 in place (see FIG. 3B).

Moreover, one of ordinary skill in the art will acknowledge the advantageous simplicity of installing a fixture assembly according to an embodiment of the invention, such as the exemplary fixture assembly 300. Essentially, a hole 130 is bored through the spa wall 125. The bore 130 may be sized such that bore positioning features 240 easily fit inside the bore diameter or, alternatively, the bore 130 may be sized such that either an interference fit or a slip fit, as is known in the art of machining, is created between the wall of the bore 130 and the bore positioning features 240.

Once the hole 130 is bored through wall 125, a retention clip according to an embodiment of the invention, such as exemplary retention clip 200, is inserted into the bore 130 such that flange 235 mates with interior surface 1251 of spa wall 125. Next, a fixture according to an embodiment of the invention, such as exemplary fixture 305, is inserted through the inside diameter of exemplary retention clip 200. As the exemplary fixture 305 is pressed through retention clip 200, retention fingers 245 are expanded outward before retracting to engage groove 310 via retention tongues 410. Once retention fingers 245 are engaged with groove 310, the assembly 300 is complete.

FIG. 4A is a cross-sectional side view of the exemplary assembled fixture assembly 300, depicted prior to insertion of fixture 305. FIG. 4B depicts the same exemplary fixture assembly 300 after fixture 305 has been inserted and locked into place via the engagement of retention tongues 410 into groove 310.

Referring to FIG. 4A, the exemplary retention clip 200 has been inserted into bore 130 in preparation for receipt of exemplary fixture 305. Flange 235 can be seen juxtaposed to interior surface 1251 of spa wall 125. Notably, although flange 235 is depicted as being essentially flat in contour, it is envisioned that some embodiments of a retention clip may include any flange contour or sealing mechanism useful for affecting a seal against interior surface 1251 of tub wall 125. As such, the presence or absence of a specific flange contour or sealing mechanism will not be construed to limit the scope of the present disclosure.

Returning to FIG. 4A, bore positioning feature 240 is depicted as extending into the bore 130, substantially perpendicular from the base surface defined by flange 235, and adjacent its wall. Retention finger 245, in its relaxed state, defines an outermost diameter that is exceeded by the diameter of bore 130. For this reason, one of ordinary skill in the art will recognize that the retention clip 200 may be easily inserted into bore 130 without interference with retention fingers 245.

Turning to the FIG. 4B illustration, fixture 305 has been inserted through retention clip 200. As such, retention finger 245 has been extended outward to engage the exterior surface 125E of wall 125. In effect, each of the plurality of retention fingers 245 is operable to translate from an at rest first position to a flexed second position. Advantageously, once engaged to exterior surface 125, retention finger 245 may leverage such engagement to apply a securing force back on fixture 305 via retention tongue 410 into groove 310. The fixture 305 is secured in place.

As can be seen, the present invention generally relates to a retention clip for securing a fixture in a hole that has been bored through a surface, with the retention clip comprising a substantially planar ring component, wherein the ring component defines an outer diameter and an inner diameter and a plurality of retention fingers, wherein each retention finger extends outward from the ring component. The fixture can be spa-related, as disclosed in connection with the exemplary embodiments, also can be related to other water-related devices and fixtures, and also can be related to the more general category of attaching other types of fixtures or devices through holes.

Embodiments of the retention clip have a plurality of retention fingers arrayed along a circumferential path that is substantially concentric with the inner diameter of the ring component. In other embodiments, the plurality of retention fingers defines a diameter that is less than the inner diameter of the ring component and the diameter defined by the retention fingers is suitable for receipt of a fixture component. In further embodiments, each of the plurality of retention fingers is operable to translate from an at rest first position to a flexed second position.

The retention clip is operable to secure the position of an inserted fixture when the plurality of retention fingers is translated to the flexed second position. For example, an inserted fixture can be secured by a retention tongue feature comprised within one or more retention fingers. Preferably, the retention fingers are in contact with the surface when in the flexed second position.

The retention clip also further can comprise one or more bore positioning features, wherein the bore positioning features are operable to position the retention clip within the hole. Additionally, in certain embodiments, the substantially planar ring component can be operable to affect a seal with the surface.

Devices and methods for the retention clip and spa fitting assembly have been described using detailed descriptions of embodiments thereof that are provided by way of example and are not intended to limit the scope of the disclosure. It will be appreciated by persons skilled in the art that devices and methods for the provision of a retention clip and/or spa fitting assembly is not limited by what has been particularly shown and described herein above. That is, although selected aspects have been illustrated and described in detail, it will be understood that various substitutions and alterations may be made therein without departing from the spirit and scope of the present invention. As such, the scope of the devices and methods for the provision of a retention clip and/or spa fitting assembly is defined solely by the claims that follow.

What is claimed is:

1. A retention clip for securing a fixture in a hole that has been bored through a surface, the retention clip comprising:
a substantially planar ring component, wherein the ring component defines an outer diameter and an inner diameter; and
a plurality of retention fingers, wherein each retention finger extends outward from the ring component.

2. The retention clip of claim 1, wherein the plurality of retention fingers is arrayed along a circumferential path that is substantially concentric with the inner diameter of the ring component.

3. The retention clip of claim 2, wherein the plurality of retention fingers defines a diameter that is less than the inner diameter of the ring component and the diameter defined by the retention fingers is suitable for receipt of a fixture component.

4. The retention clip of claim 3, wherein each of the plurality of retention fingers is operable to translate from an at rest first position to a flexed second position.

5. The retention clip of claim 4, wherein the retention clip is operable to secure the position of an inserted fixture when the plurality of retention fingers is translated to the flexed second position.

6. The retention clip of claim 5, wherein an inserted fixture is secured by a retention tongue feature comprised within one or more retention fingers.

7. The retention clip of claim 5, wherein the retention fingers are in contact with the surface when in the flexed second position.

8. The retention clip of claim 1, further comprising one or more bore positioning features, wherein the bore positioning features are operable to position the retention clip within the hole.

9. The retention clip of claim 1, wherein the substantially planar ring component is operable to affect a seal with the surface.

10. A mounted spa fixture assembly, the assembly comprising:
a retention clip inserted into a hole bored through a spa surface, the retention clip comprising:
a substantially planar ring component, wherein the ring component defines an outer diameter and an inner diameter; and
a plurality of retention fingers that defines a diameter that is less than the inner diameter of the ring component, wherein each retention finger includes a retention tongue feature and extends upward from the ring component; and
a spa fixture comprising a retention groove and inserted through the diameter defined by the retention fingers such that the retention tongue features of the retention fingers are received by the retention groove.

11. The spa fixture assembly of claim 10, wherein the plurality of retention fingers is arrayed along a circumferential path that is substantially concentric with the inner diameter of the ring component.

12. The spa fixture assembly of claim 10, wherein the retention fingers are in contact with the spa surface.

13. The spa fixture assembly of claim 10, wherein the retention clip further comprises one or more bore positioning features that position the retention clip within the hole.

14. The spa fixture assembly of claim 10, wherein the substantially planar ring component is operable to affect a seal with the spa surface.

15. A method for securing a fixture in a hole that has been bored through a surface, the method comprising the steps of:
inserting a retention clip into a hole that was bored through the surface, wherein the retention clip comprises:
a substantially planar ring component that defines an outer diameter and an inner diameter;
one or more bore positioning features that serve to position the retention clip within the hole; and
a plurality of retention fingers that defines a diameter that is less than the inner diameter of the ring component, wherein each retention finger includes a retention tongue feature and extends upward from the ring component; and
inserting a fixture comprising a retention groove through the diameter defined by the retention fingers such that the retention tongue features of the retention fingers are received by the retention groove;
wherein the fixture is secured in the hole by virtue of the retention groove receiving the retention tongue features of the clip.
